(19) United States
(12) Patent Application Publication
(10) Pub. No.: US 2010/0191944 A1
(43) Pub. Date: Jul. 29, 2010

(54) DATA STORAGE APPARATUS

(75) Inventors: Kenichi NUMATA, Ome-shi (JP); Teruji YAMAKAWA, Koto-ku (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/695,929

(22) Filed: Jan. 28, 2010

(30) Foreign Application Priority Data
Jan. 29, 2009 (JP) 2009-18310

(51) Int. Cl. G06F 9/00

(52) U.S. Cl. 713/1

(57) ABSTRACT

According to one embodiment, a data storage apparatus includes: a storage element including a user data storage area and an area for storing multiplexed pre-boot authentication applications; and a controller connected to a host and performs read/write access to the user data area when an authentication by the pre-boot authentication application is verified. The controller determines whether the data storage apparatus is connected to the host in a form in which the host performs time-out monitoring or the data storage apparatus is connected to the host in a form in which the host does not perform the time-out monitoring. The controller performs, when the controller determines that the data storage apparatus is connected to the host in the form in which the host does not perform the time-out monitoring, mirroring synchronization of the multiplexed pre-boot authentication applications at the time of booting.

### CROSS-REFERENCE TO RELATED APPLICATIONS

This application is based upon and claims the benefit of priority from Japanese Patent Application No. 2009-018310, filed Jan. 29, 2009, the entire contents of which are incorporated herein by reference.

### BACKGROUND

1. Field

One embodiment of the invention relates to a data storage apparatus having a data security function for a storage medium.

2. Description of the Related Art

With development of information processing technology in recent years, various types of user data for business operations are stored in a data storage apparatus. In view of the importance of the user data in a data storage apparatus, data storage apparatus having data security function has been demanded increasingly in recent years from the viewpoints of protecting confidential information and avoiding information leakage.

For security data storage apparatuses, the pre-boot authentication (PBA) application is for example proposed (for example, see Japanese Patent Application Publication (KOKAI) No. 2006-268861).

In a data storage apparatus including the PBA function executed before booting an operating system (OS), the PBA application stored in the data storage apparatus is booted before the OS booting, and a user authentication is performed with a password and the like. When the authentication is verified, a master boot recorder (MBR) performs a boot operation to boot the OS. In this way, a computer executes the application under the control of the OS, and the user data in the data storage apparatus become accessible.

A PBA application stored in a data storage apparatus is updated when a backup is performed, or a security patch is applied. When a power shutdown occurs while updating the PBA application, the PBA application may break down. If the PBA application breaks down when there is only one PBA application in the data storage apparatus, the PBA application and the OS cannot be booted unless the PBA application is restored by using a recovery disk or the like, such as a compact disk (CD).

In order to boot the PBA application in the aforementioned case, multiple PBA applications may be stored in the data storage apparatus to perform, at the first power-on after the PBA application breaks down, synchronization in the data storage apparatus.

A basic input/output system (BIOS) of a personal computer (PC) normally performs recognition processing on the data storage apparatus at the time of booting. When a long time is required to perform the synchronization in the data storage apparatus, a time-out may occur in the recognition processing, and the data storage apparatus may not be recognized.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a data storage apparatus according to an embodiment of the invention;

FIG. 2 is an exemplary block diagram of a system to which the data storage apparatus is internally provided in the embodiment;

FIG. 3 is an exemplary block diagram of a system to which the data storage apparatus is externally provided in the embodiment;

FIG. 4 is an exemplary explanatory diagram of multiplexing of a pre-boot authentication application in the embodiment;

FIG. 5 is an exemplary explanatory diagram of flags for synchronization of the multiplexed pre-boot authentication applications in FIG. 4 in the embodiment;

FIG. 6 is an exemplary flowchart of update processing of the pre-boot authentication application in the embodiment;

FIG. 7 is an exemplary flowchart of update completion processing of the pre-boot authentication application in the embodiment;

FIG. 8 is an exemplary flowchart of update cancellation processing of the pre-boot authentication application in the embodiment;

FIG. 9 is an exemplary flowchart of determination of the synchronization at the time of booting in the embodiment;

FIG. 10 is an exemplary flowchart of the synchronization in the embodiment; and

FIG. 11 is an exemplary flowchart of the synchronization in background in the embodiment.

### DETAILED DESCRIPTION

Various embodiments according to the invention will be described hereinafter with reference to the accompanying drawings, in the order of a data storage apparatus with a security function, a pre-boot authentication application, synchronization of the pre-boot authentication applications at the time of power on, and other embodiments. In general, according to one embodiment of the invention, a data storage apparatus, comprises: a storage element comprising a user data storage area for storing user data and an area for storing a pre-boot authentication application for authenticating access to the user data; and a controller connected to a host and configured to perform read/write access to the user data area when an authentication by the pre-boot authentication application is verified, wherein the pre-boot authentication application is multiplexed and stored in the storage element, the controller is configured to determine whether the data storage apparatus is connected to the host in a form in which the host performs time-out monitoring or the data storage apparatus is connected to the host in a form in which the host does not perform the time-out monitoring, from a command sequence issued from the host at a time of booting, and the controller is configured to perform, when the controller determines that the data storage apparatus is connected to the host in the form in which the host does not perform the time-out monitoring, mirroring synchronization of the multiplexed pre-boot authentication applications at the time of booting.

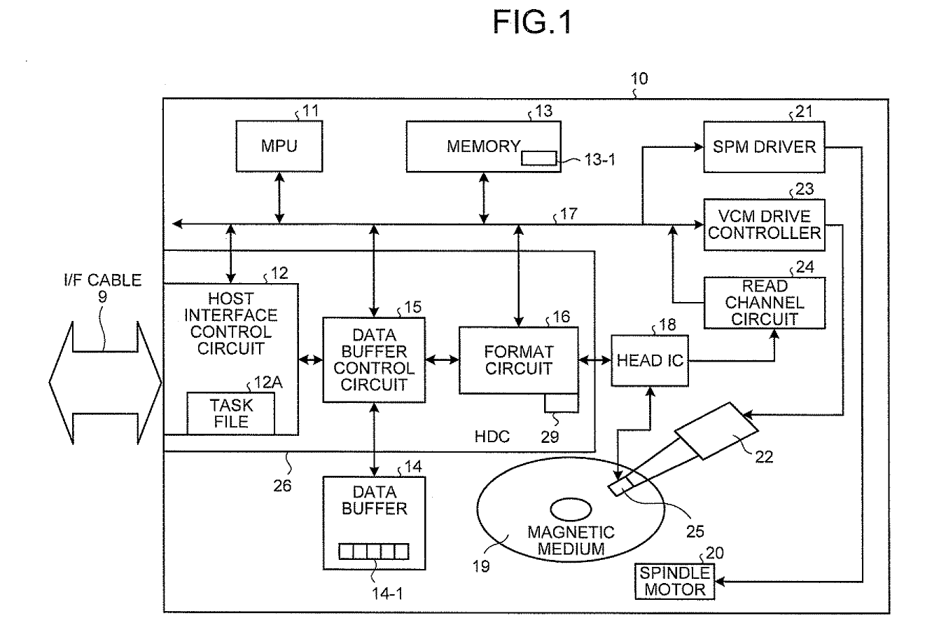

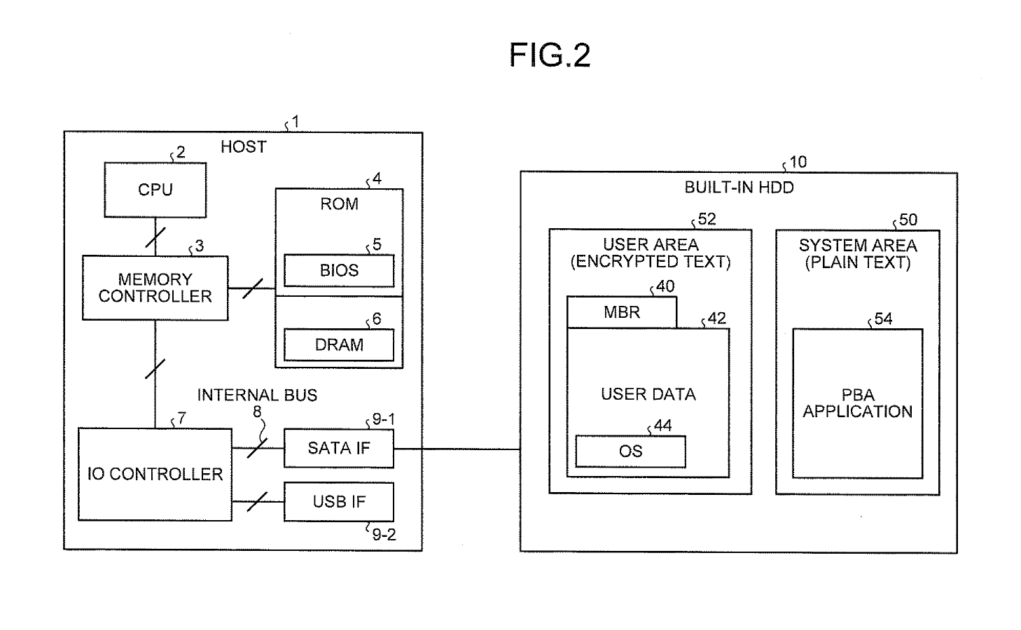

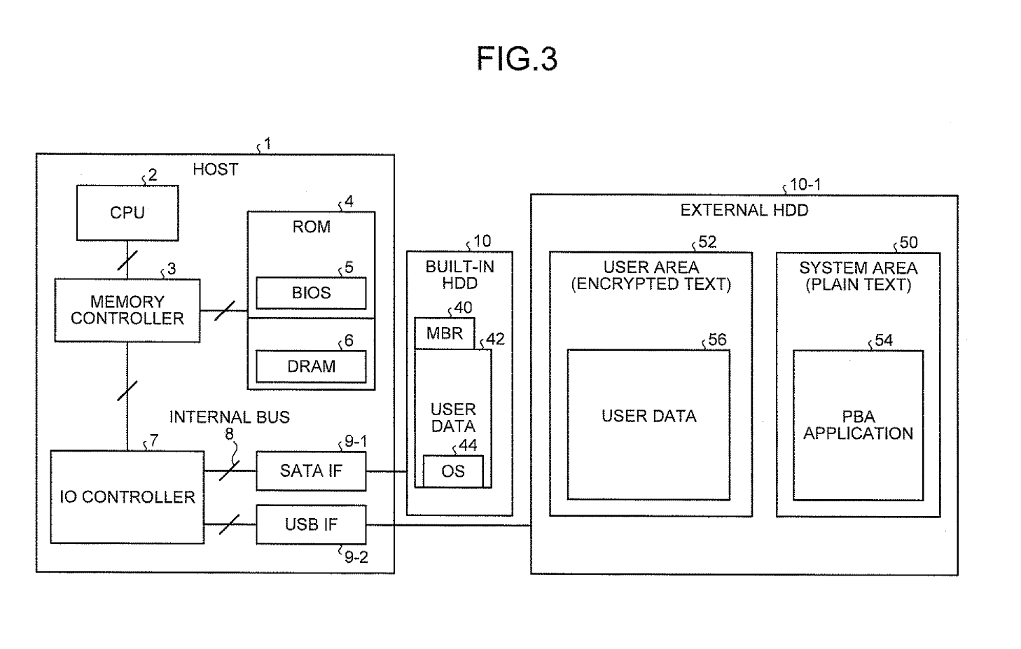

FIG. 1 is a block diagram of a data storage apparatus according to one embodiment of the invention; FIG. 2 is a block diagram of a system in which the data storage apparatus of FIG. 1 is internally provided (installed); and FIG. 3 is a block diagram of the system in which the data storage apparatus of FIG. 1 is externally provided. As the data storage apparatus, FIG. 1 exemplifies a magnetic disk apparatus (hereinafter referred also to as a hard disk drive (HDD)) that reads/writes data from/to a magnetic disk (magnetic medium).

As illustrated in FIG. 1, the magnetic disk apparatus 10 is connected to a host such as a personal computer (PC) via an interface such as ones based on serial AT attachment (SATA) and universal serial bus (USB) standards. The magnetic disk apparatus 10 comprises a disk enclosure and a control board.

The disk enclosure comprises a magnetic medium 19, a spindle motor (SPM) 20 for rotating the magnetic medium 19, a magnetic head 25 for reading data from or writing data to the magnetic medium 19, an actuator (voice coil motor (VCM)) 22 for moving the magnetic head 25 in a radial direction of the magnetic medium 19 (track traversing direction), and a head IC 18.

The control board comprises a hard disk controller (HDC) 26. The HDC 26 comprises a host interface control circuit 12 for controlling an interface with the host, a data buffer control circuit 15 for controlling a data buffer 14, a format circuit 16 for controlling reading/writing, converting a format of recording data, and inversely converting read data. An encryption circuit 29 for encrypting/decrypting data is provided in the format circuit 16.

Also, the control board comprises a read channel circuit 24, a micro processing unit (MPU) 11, a memory (volatile memory (random access memory (RAM)) and non-volatile memory) 13, an SPM driver 21 for drive-controlling the spindle motor 20, a voice coil motor (VCM) drive controller 23 for drive-controlling the VCM 22, and a bus 17 for connecting the above components.

The host interface control circuit 12, the data buffer control circuit 15, the format circuit 16, and the head IC 18 are connected to one another by a data bus. The read channel circuit 24 is connected to the head IC 18.

The read channel circuit 24 demodulates the read data and generates a read gate, a write gate, a read clock, and a write clock. The data buffer 14 functions as a cache memory, stores write data from the host, and stores the read data from the magnetic medium 19. The write data in the data buffer 14 is written to the magnetic medium 19 in a write-back, and the read data in the data buffer 14 is transferred to the host while reading.

The head IC 18 provides a recording current to the magnetic head 25 according to the data while writing the data, and amplifies a read signal from the magnetic head 25 to output the read signal to the read channel circuit 24 while reading the data. The MPU 11 performs position detection and position control of the magnetic head 25, analysis of a command from the host, access processing, and retry control.

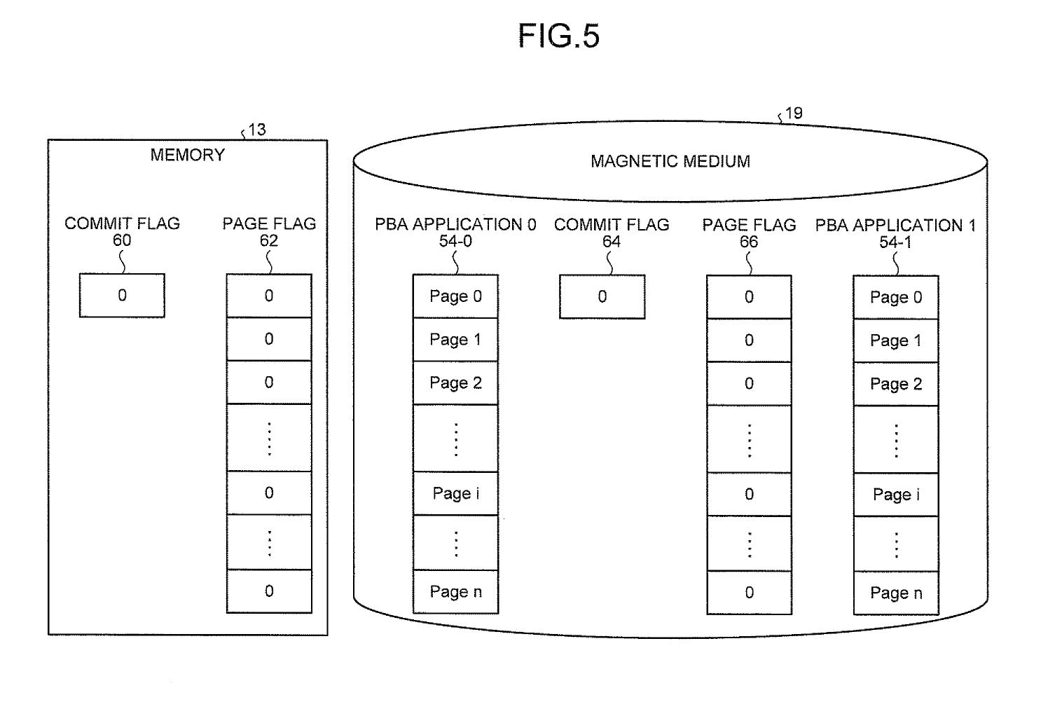

The memory (RAM and read only memory (ROM)) 13 stores data necessary for processing of the MPU 11. The memory 13 also stores a synchronization flag table 13-1 depicted in FIG. 5. The memory (ROM) 13 stores programs and parameters necessary for processing of the MPU 11.

The MPU 11 receives a servo signal of the magnetic medium 19 read by the magnetic head 25 from the head IC 18 and the read channel circuit 24, detects the position of the head, and performs seek and on-track controls on the VCM 22 via the VCM drive controller 23.

FIG. 2 is a block diagram of a data processor such as the PC in which the data storage apparatus is installed. A host 1 of the PC comprises a CPU 2, a memory controller 3, a ROM 4, a RAM 6, and an IO controller 7. These are connected by an internal bus 8.

A basic input/output system (BIOS) 5 is stored in the ROM 4, and two interface circuits 9-1 and 9-2 are connected to the IO controller 7. A built-in magnetic disk apparatus (hereinafter, referred also to as HDD) 10 is connected to the SATA IF 9-1. The other interface circuit 9-2 is a USB IF and connected to an apparatus outside the PC.

A master boot recorder (MBR) 40, user data 42, and an OS 44 of the PC are stored in a user area 52 of the magnetic medium 19 in the built-in magnetic disk apparatus 10. These are encrypted. A pre-boot authentication (PBA) application 54 is stored as a security application in a system area 50 of the magnetic medium 19.

FIG. 3 is a block diagram of a data processor such as the PC to which the data storage apparatus is externally connected. In FIG. 3, in the same way as in FIG. 2, the host 1 of the PC comprises the CPU 2, the memory controller 3, the ROM 4, the RAM 6, and the IO controller 7. These are connected by the internal bus 8.

The BIOS 5 is stored in the ROM 4, and two interface circuits 9-1 and 9-2 are connected to the IO controller 7. The built-in HDD 10 is connected to the SATA IF 9-1. The other interface circuit 9-2 is the USB IF and connected to an HDD 10-1 outside the PC.

The built-in HDD 10 configures a system disk including the OS 44, and stores the MBR 40, the user data 42, and the OS 44 of the PC in the user area 42 of the magnetic medium 19. These may be encrypted. The built-in magnetic disk apparatus 10 in FIG. 3 may store the PBA application.

User data 56 is encrypted and stored in the user area 52 of the magnetic medium 19 in the externally connected HDD 10-1. The PBA application 54 is stored as a security application in the system area 50 of the magnetic medium 19 in the HDD 10-1. The PBA application 54 stored in the externally connected HDD 10-1 is called by the OS or by an application running on the OS. When the authentication by the PBA application 54 is verified, read/write of the encrypted data 56 becomes possible.

As described above, in the built-in HDD 10, the PBA application 54 is stored in the magnetic medium 19, and used for an authentication before booting the OS. In contrast, when the external HDD 10-1 is provided, the external HDD 10-1 is used in parallel with the built-in HDD 10. In this case, the MBR 40, the user data 42, and the OS 44 are stored in the built-in HDD 10, and the PBA application 54 is stored in the external HDD 10-1. Then, and the PBA application 54 is called by the OS or the application running on the OS.

When access to the user data becomes possible by the authentication, the encryption circuit 29 becomes active, and read/write of the encrypted data becomes possible.

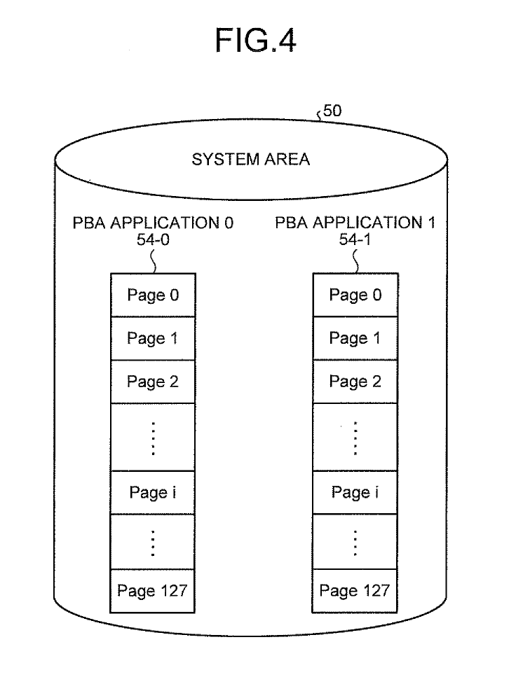

FIG. 4 is an illustration of the PBA application in the embodiment, and FIG. 5 is an illustration of synchronization of the PBA applications.

As illustrated in FIG. 4, the PBA application is multiplexed and provided in the system area 50 of the magnetic medium 19. In FIG. 4, two PBA applications 54-0 and 54-1 are disposed, or in other words, the PBA application is duplicated. Specifically, a plurality of PBA applications are provided in the data storage apparatus, and when one of the PBA applications fails, another PBA application recovers the failed PBA application by mirroring.

For the mirroring, synchronization between the PBA applications is required. The size of the PBA application having the PBA function is from tens of megabytes to hundreds of megabytes. Since the size is very large, the synchronization between the PBA applications takes a time from several seconds to tens of seconds. For example, if the synchronization is performed at power-on of the data storage apparatus, a time-out maybe detected and boot may fail in the recognition processing of the data storage apparatus by the BIOS.

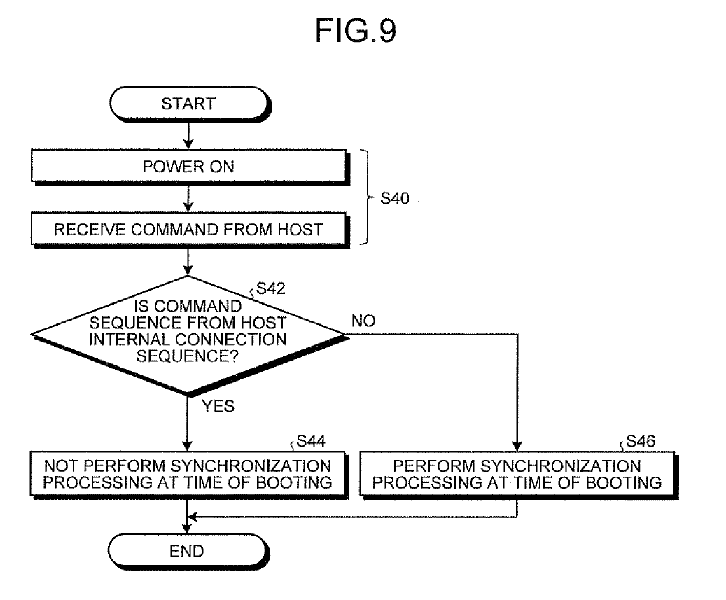

In order to prevent the time-out in the boot processing, as depicted in FIG. 9 and later, it is determined whether the data storage apparatus has a connection form in which time-out monitoring is performed (for example, the data storage apparatus is internally connected) or has a connection form in which time-out monitoring is not performed (for example, the data storage apparatus is externally connected via an interface such as USB or the like).

When the data storage apparatus is externally connected, the time-out does not matter, and hence the synchronization of the PBA applications is performed at the time of booting. When the data storage apparatus is internally connected, to surely avoid the time-out of the host, the synchronization is not performed at the time of booting. Instead, when the read/write command for the PBA application after booting is issued for the first time, the synchronization of the PBA applications is performed prior to the read/write operation.

In order to speed up the synchronization, difference processing and background synchronization are performed. As illustrated in FIG. 4, the PBA applications 0 and 1 are divided into a plurality of small areas (pages) of Pages 0 to 127. For example, each of the PBA applications 0 and 1 is assumed to have a size of 128 Mbytes, the PBA applications are divided into small areas (pages) of 1 Mbytes.

Usually, there are two types of synchronization, namely, Commit and Abort. When a write command is issued from the host, the PBA application 54-0 is updated. Thereafter, when the host requests to determine the update of the PBA application, the host issues a Commit command. When the Commit command is issued, the magnetic disk apparatus copies the PBA application 54-0 to the PBA application 54-1.

When the host requests to cancel the update of the PBA application for some reason, the host issues an Abort command. When the Abort command is issued, the magnetic disk apparatus copies the PBA application 54-1 to the PBA application 54-0 to bring back the PBA application 54-0 to the original state.

Flags for controlling the synchronization will be described with reference to FIG. 5. As illustrated in FIG. 5, in the magnetic medium 19 and the memory 13 of the magnetic disk apparatus 10, two types of flag tables 13-1, namely, Page Flag 62 and Commit Flag 60, are prepared (see FIG. 1).

The Page Flag 62 is prepared for each page, and when the write command is issued from the host to the i-th page, Page Flag [i] becomes “1”. When the synchronization is completed, the Page Flag 62 becomes “0”. The Commit Flag 60 is a flag indicating whether it is being committed or not, and when the Commit command is received from the host, the Commit Flag 60 becomes “1”. After completion of the Commit, the Commit Flag 60 becomes “0”.

By using the flag tables, normal synchronization for mirroring is performed as described below.

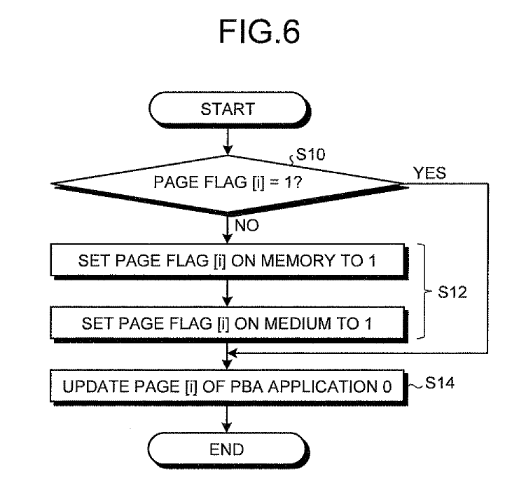

FIG. 6 is a flowchart of the update processing of the PBA application performed by the MPU 11 of the HDD.

The MPU 11 determines whether the page flag [i] of the i-th page in the memory 13 is “1” (S10). When the write command (update command) of the i-th page is received from the host, the MPU 11 sets the page flag [i] of the i-th page to “1”. When it is determined that the page flag [i] of the i-th page in the memory 13 is “1”, the MPU 11 proceeds to S14.

When it is determined that the page flag [i] of the i-th page in the memory 13 is not “1”, the MPU 11 sets the page flag [i] in the memory 13 to “1”, and sets the page flag [i] on the magnetic medium 19 to “1” (S12).

The MPU 11 updates the i-th page [i] of the PBA application in the magnetic medium 19 with the write data (update data) from the host (S14).

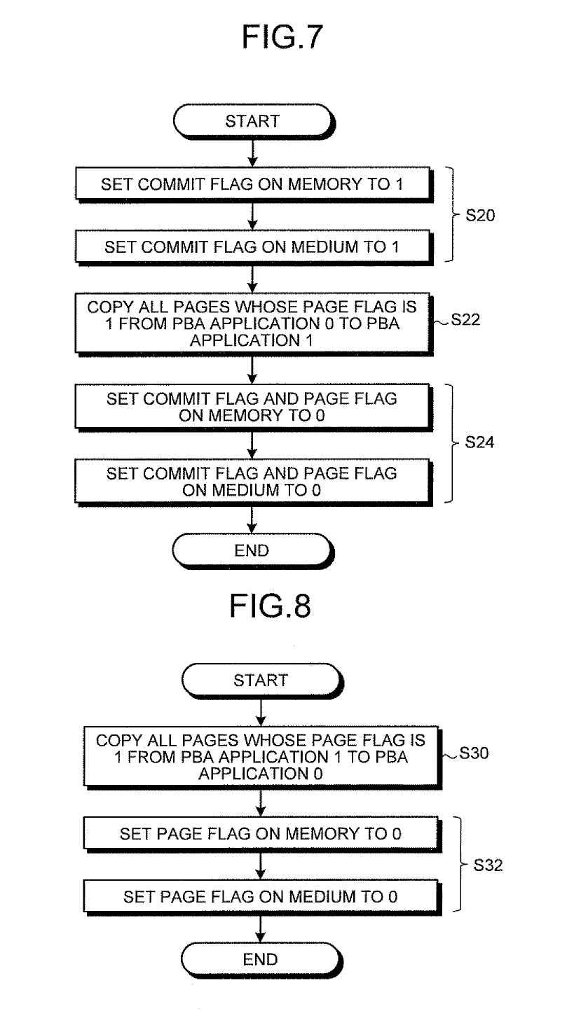

FIGS. 7 and 8 are flowcharts of the synchronization by the host command performed by the MPU 11 of the HDD. FIG. 7 is a flowchart of processing the commit command described above, and FIG. 8 is a flowchart of processing the abort command described above. First, the commit processing will be described with reference to FIG. 7.

When the commit command is received, the MPU 11 sets the commit flag in the memory 13 to “1”, and sets the commit flag on the magnetic medium 19 to “1”.

The MPU 11 copies all the pages whose page flag is “1” in the PBA application 54-0 on the magnetic medium 19 to the PBA application 54-1 (S22).

After the copy is completed, the MPU 11 sets the commit flag in the memory 13 to “0”, and sets the commit flagon the magnetic medium 19 to “0” (S24).

The abort processing will now be described with reference to FIG. 8.

When the abort command is received, the MPU 11 copies all the pages whose page flag is “1” in the PBA application 54-1 on the magnetic medium 19 to the PBA application 54-0 to bring back the PBA application 54-0 to the original state.

After completion of the copy, the MPU 11 sets the page flags in the memory 13 to “0”, and sets the page flags on the magnetic medium 19 to “0” (S32).

In this way, by using the page flags and the commit flag, the synchronization of commit and abort can be efficiently performed. In addition, the page flags and the commit flag are useful to speed up the synchronization at the time of booting, which will be described later.

FIG. 9 is a flowchart of determination of the synchronization at the time of booting according to the embodiment of the invention.

The MPU 11 of the HDD 10 receives a command sequence issued by the host 1 at the time of booting (at the time of power-on) (S40). When the data storage apparatus is internally connected in accordance with the connected port (the interface circuit in FIGS. 2 and 3), the host 1 issues an ATA security feature set command within a certain time period or issues a read/write command by a port I/O (PIO) transmission. When the data storage apparatus is externally connected, the host 1 issues, for example, a DMA read/write command from the OS.

The MPU 11 determines whether the command sequence corresponds to the internal connection or others (S42).

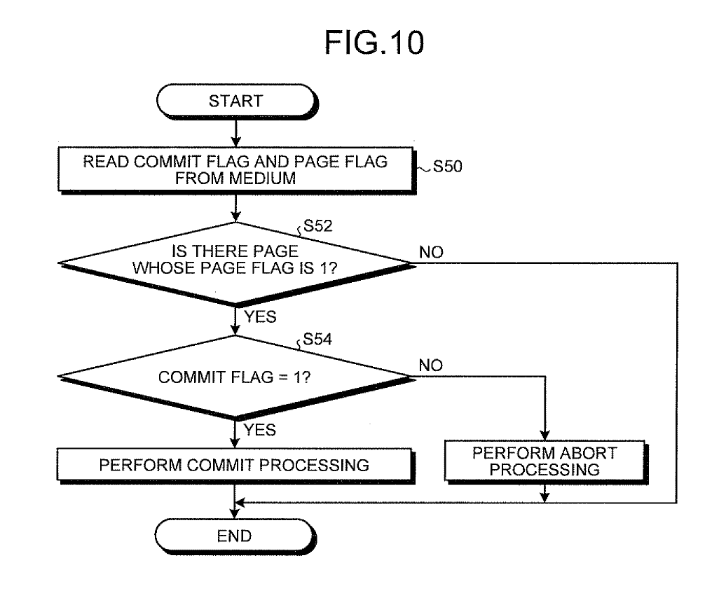

When the MPU 11 determines that the command sequence corresponds to the internal connection, the MPU 11 determines that the data storage apparatus 10 has a connection form in which time-out monitoring is performed (for example, the data storage apparatus is internally connected to be used to boot the OS), and does not perform the synchronization at the time of booting (S44). Instead, when the first read/write command to the PBA application is issued after the data storage apparatus is booted, the MPU 11 performs the synchronization illustrated in FIG. 10 before executing the read/write command, and restores the mirroring.

When the MPU 11 determines that the command sequence corresponds to the external connection, the MPU 11 determines that the data storage apparatus has a connection form in which time-out monitoring is not performed (for example, the data storage apparatus is externally connected via an interface such as USB). Since the data storage apparatus is determined to be externally connected via USB or the like, the host time-out does not matter. Therefore, the data storage apparatus 10 performs the synchronization illustrated in FIG. 10 at the time of booting, and restores the mirroring.

FIG. 10 is a flowchart of the synchronization in FIG. 9.

The MPU 11 reads the commit flag 64 and the page flags 66 from the system area of the magnetic medium 19 to the memory 13 (S50). As explained in FIG. 5 described above, since the commit flag 64 and the page flags 66 in the memory 13 are stored in the magnetic medium 19, the previous update state can be reproduced even when a power shutdown or the like occurs while the updating.

The MPU 11 determines whether there is a page whose page flag is “1” in the page flags 66 (S52). When the MPU 11 determines that there is no page whose page flag is “1”, the MPU 11 determines that there is no page on which the commit/abort processing is performed before power is turned on again, and ends the synchronization performed when power is turned on again.

In contrast, when the MPU 11 determines that there is a page whose page flag is “1”, the MPU 11 determines whether the commit flag is “1” (S54). When the commit flag is “1”, since the update of the mirroring is not completed, the MPU 11 performs the processing for the commit command from the host illustrated in FIG. 7 without receiving the host command. Specifically, as illustrated in S22 of FIG. 7, the MPU 11 copies all the pages whose page flag is “1” in the PBA application 54-0 on the magnetic medium 19 to the PBA application 54-1. Then, as illustrated in S24, after the copy is completed, the MPU 11 sets the commit flag in the memory 13 to “0”, and sets the commit flag on the magnetic medium 19 to “0”.

In contrast, when the commit flag is determined not to be “1”, since the cancellation of the update of the mirroring is not completed, the MPU 11 performs the processing from S30 to S32 of the abort command from the host illustrated in FIG. 8 without receiving the host command.

In this way, at the time of booting, the MPU 11 determines whether the data storage apparatus has a connection form in which time-out monitoring is performed or has a connection form in which time-out monitoring is not performed from the command sequence issued from the host to the data storage apparatus. When the data storage apparatus is externally connected, the time-out does not matter, so that the MPU 11 performs the synchronization of the PBA applications at the time of booting. When the data storage apparatus is internally connected, to surely avoid the time-out of boot processing of the host, the synchronization processing is not performed at the time of booting. Instead, when the read/write command to the PBA application after booting is issued for the first time, the synchronization of the PBA applications is performed before the read/write operation is performed.

Therefore, in a data storage apparatus in which the authentication function by the PBA application is redundant, even when the PBA application is broken, a delay due to a repair operation can be reduced, and the time-out in boot processing in the host can be avoided when power is turned on again.

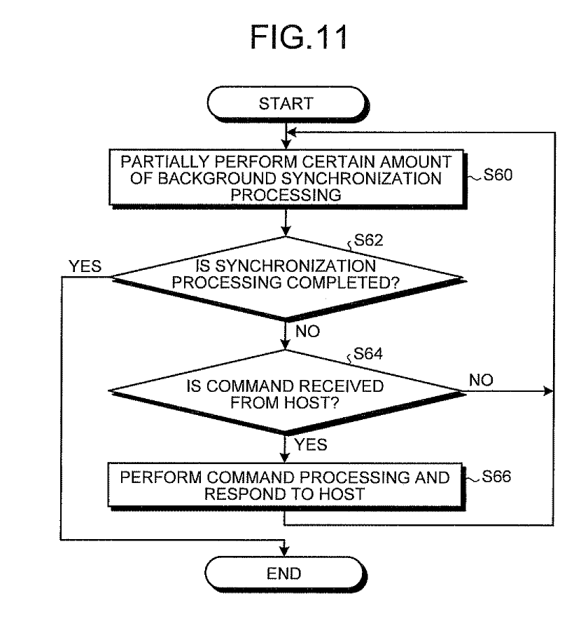

Background processing suitable to the synchronization in the internally connected data storage apparatus in S44 of FIG. 9 will now be described. FIG. 11 is a flowchart of the synchronization in background prioritizing a host response according to the embodiment of the invention.

The MPU 11 performs a certain amount (for example, 1 page=1 sector) of synchronization in background (see FIG. 10) (S60).

The MPU 11 determines whether the entire synchronization performed when power is turned on again is completed (S62). When the MPU 11 determines that the entire synchronization performed when power is turned on again is completed, the MPU 11 ends the background synchronization.

When the MPU 11 determines that the entire synchronization processing performed when power is turned on again is not completed, the MPU 11 determines whether a command from the host is received (S64). When the MPU 11 determines that a command from the host is not received, the MPU 11 returns to S60 and performs the synchronization in the background.

In contrast, when the MPU 11 determines that a command from the host is received, the MPU 11 executes the command (read/write command or the like), reports the execution result to the host, returns to S60, and performs the synchronization in the background (S66).

In this way, from the booting to when the read/write command to the PBA application is issued for the first time, the synchronization of the PBA applications is progressed in the background. In the background processing, every time a certain amount is processed, a host response is checked, so that it is possible to prioritize the host response.

For example, if the PBA application is 128 Mbytes, when applying a patch (difference is only 1 page=1 sector), it takes several seconds to complete the synchronization when performing an entire copy. However, it takes only several milliseconds to complete the synchronization when only copying a difference of the PBA application while the PBA application is divided into pages as illustrated in the embodiment.

As described above, in restoring the mirroring when the PBA application 0 or the PBA application 1 breaks down due to power shutdown or the like while updating the PBA application, whether the connection form of the data storage apparatus is internal connection or external connection is determined from the command sequence issued from the host at the time of booting. When the determination result is external connection, the host time-out does not matter, and hence the restoring of the mirroring is performed by the synchronization of the PBA applications at the time of booting of the data storage apparatus.

When the determination result is the internal connection, to avoid the time-out of boot processing of the host, the synchronization is not performed at the time of booting. Instead, when the first read/write command to the PBA application is issued after the data storage apparatus is booted, the synchronization is performed before executing read/write, and the mirroring is restored.

Therefore, when the data storage apparatus is booted, the PBA application can be restored while the host does not detect time-out.

Furthermore, from when the data storage apparatus is booted to when the read/write command to the PBA application is issued for the first time, by progressing the synchronization of the PBA applications in the background, the synchronization is efficiently performed.

In the embodiment described above, the magnetic disk apparatus is described as an example of the data storage apparatus, but the embodiment is not limited thereto, and the data storage apparatuses can be applied to a solid-state memory device such as a solid state disk (SSD), other disk apparatus such as an optical disk, and a card device.

In addition, other forms of PBA application can be used if the PBA application performs the authentication and boots MBR. Although it is extremely effective to combine the PBA application and encryption with respect to security, encryption may be omitted if necessary.

According to the aforementioned embodiments, even when the PBA application is multiplexed and updated, the time-out of the host can be prevented, and the synchronization can be performed.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data storage apparatus, comprising:
a storage device comprising a user data storage area configured to store user data and an area configured to store a pre-boot authentication application for authenticating access to the user data; and
a controller connected to a host and configured to execute read/write access to the user data area when an authentication by the pre-boot authentication application is verified, wherein
the pre-boot authentication application is multiplexed and stored in the storage device,
the controller is configured to determine whether the host connected to the data storage apparatus is monitoring connection time-out, from a command sequence issued from the host at a time of booting, and
the controller is configured to perform mirroring synchronization of the multiplexed pre-boot authentication applications at the time of booting, when the controller determines that the host connected to data storage apparatus is not monitoring the connection time-out.

2. The data storage apparatus of claim 1, wherein the controller is configured to perform the mirroring synchronization of the multiplexed pre-boot authentication applications after the booting when the controller receives a read/write command for the pre-boot authentication application from the host for the first time, if the controller determines that the host connected to the data storage apparatus is monitoring the connection time-out.

3. The data storage apparatus of claim 2, wherein the controller is configured to perform the mirroring synchronization on the multiplexed pre-boot authentication applications before executing the read/write command, when the controller receives the read/write command for the pre-boot authentication application from the host for the first time.

4. The data storage apparatus of claim 1, wherein
the storage device is configured to store area flags, the area flags configured to store current states of a plurality of areas in the area configured to store the pre-boot authentication application, and
the controller is configured to perform the mirroring synchronization on the multiplexed pre-boot authentication applications only on at least one of the plurality of areas updated based on the area flags.

5. The data storage apparatus of claim 2, wherein the controller is configured to perform the mirroring synchronization of the multiplexed pre-boot authentication applications after the booting when the controller has not received any command from the host, if the controller determines that the host connected to the data storage apparatus is monitoring the connection time-out.

6. The data storage apparatus of claim 1, wherein the pre-boot authentication application is configured to be booted by the basic input/output system (BIOS) of the host, and the host is configured to boot an operating system (OS) when the authentication of the pre-boot authentication application by the host is verified.

7. The data storage apparatus of claim 1, wherein the data storage apparatus is installed in an apparatus comprising the host when the host connected to the data storage apparatus is monitoring the connection time-out, and
the data storage apparatus is externally connected to the apparatus comprising the host when the host connected to the data storage apparatus is connected is not monitoring the connection time-out.

8. The data storage apparatus of claim 4, wherein the controller is configured to receive a write command for the pre-boot authentication application from the host, and to set at least one of the area flags to on in updating a first one of the multiplexed pre-boot authentication applications.

9. The data storage apparatus of claim 8, wherein the controller is configured to copy the first multiplexed pre-boot authentication application to an area of a second multiplexed pre-boot authentication application in the synchronization in response to a commit command from the host, after the first the multiplexed pre-boot authentication application is updated.

10. The data storage apparatus of claim 9, wherein the controller is configured to set a commit flag to on in response to the commit command from the host, to copy the first multiplexed pre-boot authentication application to the area of the second the multiplexed pre-boot authentication application, and to set the commit flag to “off” in the synchronization.

11. The data storage apparatus of claim 10, wherein the controller is configured to copy the first multiplexed pre-boot authentication application to the area of the second multiplexed pre-boot authentication application, and set the commit flag to “off” in the synchronization, when the at least one of the area flags is on and the commit flag is on at the time of booting.

12. The data storage apparatus of claim 9, wherein the controller is configured to copy data of the area of the second multiplexed pre-boot authentication application to the updated area comprising an area flag being on of the one of the multiplexed pre-boot authentication applications, and to set the area flags to “off” in the synchronization, in response to an abort command from the host.

13. The data storage apparatus of claim 12, wherein the controller is configured to copy data of the area of the second multiplexed pre-boot authentication application to the updated area comprising an area flag being on of the one of the multiplexed pre-boot authentication applications, and to set the area flag to “off” in the synchronization, when the area flag is on and the commit flag is “off” at the time of booting.

14. The data storage apparatus of claim 1, wherein the storage device comprises a storage medium and a head configured to read data from the storage medium and to write data to the storage medium.
